(19) United States
(12) Patent Application Publication
(10) Pub. No.: US 2015/0012711 A1
(43) Pub. Date: Jan. 8, 2015

(54) SYSTEM AND METHOD FOR ATOMICALLY UPDATING SHARED MEMORY IN MULTIPROCESSOR SYSTEM

(71) Applicants: VAKUL GARG, Shahdara (IN); Varun Sethi, New Delhi (IN); Bharat Bhushan, Disst Rewari (IN)

(72) Inventors: VAKUL GARG, Shahdara (IN); Varun Sethi, New Delhi (IN); Bharat Bhushan, Disst Rewari (IN)

(21) Appl. No.: 13/935,550

(22) Filed: Jul. 4, 2013

(51) Int. Cl. G06F 12/08

(52) U.S. Cl. CPC G06F 12/084
USPC 711/130

(57) ABSTRACT

A system for operating a shared memory of a multiprocessor system includes a set of processor cores and a corresponding set of core local caches, a set of I/O devices and a corresponding set of I/O device local caches. Read and write operations performed on a core local cache, an I/O device local cache, and the shared memory are governed by a cache coherence protocol (CCP) that ensures that the shared memory is updated atomically.

### BACKGROUND OF THE INVENTION

The present invention relates generally to multiprocessor systems, and, more particularly, to a system and method for atomically updating shared memory in a multiprocessor system.

Multiprocessor systems are used in applications that require heavy data processing. These systems include multiple processor cores that process several instructions in parallel. Multiprocessor systems may include several input/output (I/O) devices to receive input data and instructions and provide output data. The instructions and data are stored in a shared memory that is accessible to the processor cores and the I/O devices. To improve performance, multiprocessor systems are equipped with fast memory chips for implementing cache memory, where the cache memory access times are considerably less than that of the shared memory. Each processor core and I/O device store data and instructions that have a high probability of being accessed in a processing cycle in a local cache. When data required by a processor core and/or an I/O device is available in its corresponding cache, the slower shared memory is not accessed, which reduces data access time and total processing time.

Such a multiprocessor system having a shared memory and local cache memory for each of the processor cores and the I/O devices operates based on a cache coherence protocol. The cache coherence protocol ensures that changes in the values of shared operands are propagated throughout the system in a timely fashion. The cache coherence protocol also governs the read/write operations performed on the shared memory by the processor cores and the I/O devices. The cache coherence protocol ensures that the updates made by writers to the shared memory are visible to the respective readers. To ensure that these updates are atomic, mechanisms like read and write locks can be used to prevent readers from accessing transient data. Typically, this is achieved by allowing either the readers or writers to access the shared memory at a given time instant.

However, there are situations where the conventional locking mechanism cannot ensure atomicity. For example, an I/O device may be unable to locate valid data in an associated cache memory during which, in accordance with the cache coherence protocol, the request is redirected to a cache memory of a processor core. However, if the processor core is in the process of updating its cache, the read operation leads to the I/O device being provided with transient data, which may lead to erroneous outputs being generated by the multiprocessor system.

Therefore, it would be advantageous to have a system and method for providing atomic updates to the shared memory of a multiprocessor system that prevents the I/O devices from accessing transient data, reduces duration of processing cycles, and overcomes the above-mentioned limitations of the conventional systems and methods for updating shared memory of multiprocessor systems.

### BRIEF DESCRIPTION OF THE DRAWINGS

The following detailed description of the preferred embodiments of the present invention will be better understood when read in conjunction with the appended drawings. The present invention is illustrated by way of example, and not limited by the accompanying figures, in which like references indicate similar elements.

FIG. 1 is a schematic block diagram of a multiprocessor system in accordance with an embodiment of the present invention; and

FIG. 2 is a flow chart of a method for operating a shared memory of a multiprocessor system in accordance with an embodiment of the present invention.

### DETAILED DESCRIPTION OF THE PRESENT INVENTION

The detailed description of the appended drawings is intended as a description of the currently preferred embodiments of the present invention, and is not intended to represent the only form in which the present invention may be practiced. It is to be understood that the same or equivalent functions may be accomplished by different embodiments that are intended to be encompassed within the spirit and scope of the present invention.

In an embodiment of the present invention, a method for operating a shared memory of a multiprocessor system is provided. The multiprocessor system includes a set of processor cores and a corresponding set of core local caches, and a set of input/output (I/O) devices and a corresponding set of I/O device local caches. The shared memory is shared between the set of processor cores and the set of I/O devices. The method includes updating data stored in a core local cache of the set of core local caches by an associated processor core of the set of processor cores. The data stored in the core local cache is transmitted to the shared memory after being updated by the processor core. After transmission of the data stored in the core local cache to the shared memory, data stored in an I/O device local cache of the set of I/O device local caches is flagged as invalid by the processor core. The I/O device local cache is accessed by an associated I/O device of the set of I/O devices. A validity of the data stored in the I/O device local cache is determined by the I/O device. The data stored in the I/O device local cache is read when the data is determined to be valid. Data stored in the shared memory is accessed when the data stored in the I/O device local cache is determined to be invalid. The data stored in the shared memory is accessed by the I/O device.

In another embodiment of the present invention, a multiprocessor system is provided. The multiprocessor system includes a shared memory, a set of core local caches that is connected to the shared memory and a set of I/O device local caches that is connected to the shared memory. The set of I/O device local caches receive and store data stored in the shared memory. The multiprocessor system further includes a set of processor cores that is connected to the set of core local caches for updating the data stored in the set of core local caches. Further, at least one processor core of the set of processor cores is associated with at least one core local cache of the set of core local caches. The processor core locks the core local cache while updating the data stored therein, transmits the data stored in the core local cache to the shared memory, and flags data stored in a I/O device local cache of the set of I/O device local caches as invalid, subsequent to the transmission of the data stored in the core local cache to the shared memory.

The system further includes a set of I/O devices connected to the set of I/O device local caches. At least one I/O device is associated with the at least one I/O device local cache. The I/O device determines a validity of the data stored in the I/O device local cache, reads the data stored in the I/O device local cache when the data is determined to be valid, and accesses the data stored in the shared memory when the data stored in the I/O device local cache is determined to be invalid.

Various embodiments of the present invention provide a system and method for operating a shared memory of a multiprocessor system. The multiprocessor system includes a set of processor cores that have a corresponding set of core local caches, and a set of I/O devices having a corresponding set of I/O device local caches. The read and write operations performed on a core local cache, an I/O device local cache, and the shared memory are governed by a cache coherence protocol (CCP) such that the shared memory is updated atomically. The CCP ensures that only the I/O devices are the valid readers that are capable of performing read operations on the set of I/O device local caches. Additionally, the CCP defines a cache coherence domain for managing read access requests generated by the I/O devices. The cache coherence domain includes only the I/O devices, the I/O device local caches, and the shared memory.

The processor core updates data stored in the core local cache in a write operation and subsequent to updating the core local cache transmits the updated data to the shared memory. The processor core also flags data stored in the I/O device local cache as invalid after successfully transmitting the updated data to the shared memory. When an I/O device associated with the I/O device local cache initiates a read access request and is unable to locate valid data in the I/O device local cache, the I/O device is redirected to the shared memory for locating valid data (apart from the I/O device local caches, the shared memory is the only other member of the cache coherence domain). Redirecting the read access request to the core local cache instead of the shared memory increases the probability of the I/O device accessing the core local cache when it is still being updated by the processor core and accessing the core local cache when it is updated by the processor core leads to transient data being provided to the I/O device. However, in the multiprocessor system of the present invention, the updated data is transmitted to the shared memory only when the write operation of the processor cores on the core local cache is complete and hence, the shared memory receives updated valid data. The updated valid data is then transmitted to the I/O device local cache in response to the redirected read access request of the I/O device. The I/O device reads the updated data from the I/O device local cache.

Leaving the core local cache out of the cache coherence domain results in the read access request of the I/O device being redirected to the shared memory rather than to the core local cache. This prevents the I/O device from being provided the transient data which in turn eradicates any probability of erroneous output being generated by the multiprocessor system. Since the CCP entails transmission of the updated data from the core local cache to the shared memory, the shared memory holds most recently updated data that is provided to the I/O device based on the read access request.

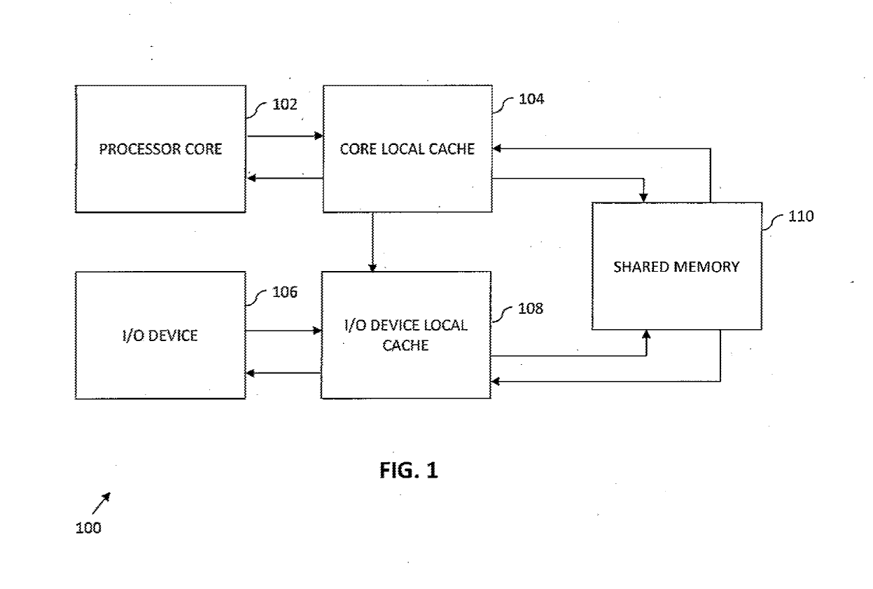

Referring now to FIG. 1, a multiprocessor system 100 in accordance with an embodiment of the present invention is shown. The multiprocessor system 100 includes a plurality of processor cores 102 (of which one is shown), a plurality of core local caches 104 (of which one is shown), a plurality of I/O devices 106 (of which one is shown), a plurality of I/O device local caches 108 (of which one is shown), and a shared memory 110. Examples of the I/O device 106 include input/output memory management unit (IOMMU), pattern matching engine, frame classification hardware, and the like. Each processor core 102 has a corresponding core local cache 104 and each I/O device 106 has a corresponding I/O device local cache 108. The core local cache 104 and the I/O device local cache 108 are connected to the shared memory 110. It will be understood by those of skill in the art that the device local cache memories may be directly connected to the shared memory 110 (as shown) or indirectly connected to the shared memory 110 such as by way of the cores.

The processor cores 102 process instructions, provided by way of the I/O devices 106, in parallel. Data and instructions that have a high probability of being accessed in a processing cycle by the processor core 102 and the I/O device 106 are pre-fetched from the shared memory 110 and stored in the core local cache 104 and the I/O device local cache 108. In an embodiment of the present invention, the I/O device 106 reads a data structure from the shared memory 110 and stores it in the I/O device local cache 108. The I/O device 106 then applies rules or information stored in the data structure for transaction processing or work processing. An example data structure is an I/O transaction authorization and translation table used by an IOMMU. As known by those of skill in the art, this table contains entries for each I/O device, where each entry comprises multiple words. According to the present invention, the entries can be updated atomically.

Multiple read/write operations are conducted on the shared memory 110, the core local cache 104, and the I/O device local cache 108. The various read/write operations are governed by a CCP, viz., CoreNet™ coherence fabric. For example, in some embodiments, coherency domain conforms to coherence, consistency and caching rules specified by Power Architecture® technology standards as well as transaction ordering rules and access protocols employed in a CoreNet™ interconnect fabric. The Power Architecture and Power.org word marks and the Power and Power.org logos and related marks are trademarks and service marks licensed by Power.org. Power Architecture® technology standards refers generally to technologies related to an instruction set architecture originated by IBM, Motorola (now Freescale Semiconductor) and Apple Computer. CoreNet is a trademark of Freescale Semiconductor, Inc.

In accordance with the CCP of the present invention, only the I/O device 106 is a valid reader that is capable of performing read operations on the I/O device local cache 108. Further, only the I/O device local cache 108 and the shared memory 110 are in the cache coherence domain.

The processor core 102 updates data stored in the core local cache 104 in a write operation to store/update one or more data words therein. During the write operation, the processor core 102 locks the core local cache 104 so as to prevent contents stored therein from being flushed to the shared memory 110 by a cache replacement algorithm running on the processor core 102. The updated data is then transmitted to the shared memory 110 by the processor core 102 and the lock on the core local cache 104 is removed. Subsequent to the successful storage of the updated data in the shared memory 110, the processor core 102 flags data stored in the I/O device local cache 108 as invalid.

Further, the I/O device 106 initiates a read access request for the I/O device local cache 108 and determines a validity of the data stored therein. Since the data stored in the I/O device local cache 108 is flagged as invalid, the read access request is redirected to the shared memory 110 which is the only other member (apart from the I/O device local cache 108) of the cache coherence domain. Since the updated data is successfully received from the core local cache 104 and stored in the shared memory 110, the shared memory 110 transmits the updated data to the I/O device local cache 108 in response to the redirected read access request. The updated data is stored in the I/O device local cache 108 and is thereafter accessed by the I/O device 106.

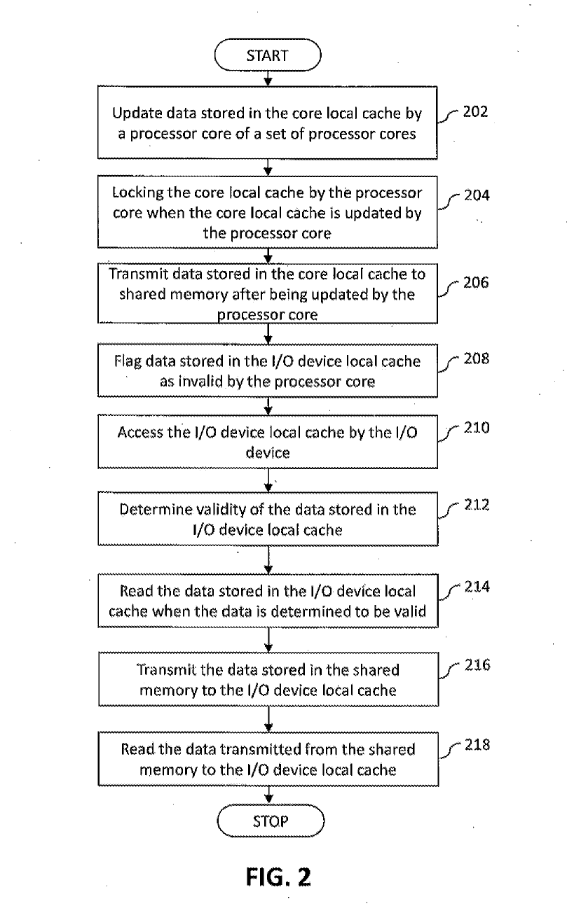

Referring now to FIG. 2, a flow chart of a method for operating the shared memory 110 of the multiprocessor system 100 in accordance with an embodiment of the present invention is shown.

At step 202, the data stored in the core local cache 104 is updated by the processor core 102 in a write operation. At step 204, the core local cache 104 is locked by the processor core 102 when the processor core 102 performs the write operation on the core local cache 104. The lock on the core local cache 104 prevents contents stored therein from being flushed to the shared memory 110 by a cache replacement algorithm running on the processor core 102. At step 206, subsequent to the completion of the write operation, the processor core 102 transmits the updated data stored in the core local cache 104 and the lock on the core local cache 104 is removed. At step 208, the processor core 102 flags the data stored in the I/O device local cache 106 as invalid. At step 210, the I/O device 106 accesses the I/O device local cache 108 to perform a read access thereon. At step 212, the I/O device 106 determines a validity of the data stored in the I/O device local cache 108. At step 214, if the data stored in the I/O device local cache 108 is determined to be valid, the I/O device 106 reads the data stored therein. At step 216, if the data stored in the I/O device local cache 108 is determined to be invalid, then the read access request is redirected to the shared memory 110 which is the only other member of the cache coherence domain apart from the I/O device local cache 108. The shared memory 110 transmits the updated data to the I/O device local cache 108. At step 218, the I/O device 106 reads the updated data stored in the I/O device local cache 108.

While various embodiments of the present invention have been illustrated and described, it will be clear that the present invention is not limited to these embodiments only. Numerous modifications, changes, variations, substitutions, and equivalents will be apparent to those skilled in the art, without departing from the spirit and scope of the present invention, as described in the claims.

1. A method for operating a shared memory of a multiprocessor system, the multiprocessor system including a set of processor cores and a corresponding set of core local caches, and a set of input/output (I/O) devices and a corresponding set of I/O device local caches, the shared memory being shared between the set of processor cores and the set of I/O devices, the set of processor cores including at least one processor core and the set of I/O devices including at least one I/O device, the method comprising:
updating data stored in a core local cache of the set of core local caches by an associated processor core of the set of processor cores;
transmitting the data stored in the core local cache to the shared memory after being updated by the processor core;
flagging data stored in an I/O device local cache of the set of I/O device local caches as invalid by the processor core, subsequent to the transmission of the data stored in the core local cache to the shared memory;
accessing the I/O device local cache by an associated I/O device of the set of I/O devices;
determining a validity of the data stored in the I/O device local cache by the I/O device;
reading the data stored in the I/O device local cache when the data is determined to be valid; and
accessing data stored in the shared memory when the data stored in the I/O device local cache is determined to be invalid, wherein the data stored in the shared memory is accessed by the I/O device.

2. The method of claim 1, further comprising locking the core local cache by the processor core when the core local cache is updated by the processor core.

3. The method of claim 2, wherein accessing the data stored in the shared memory further comprises:
transmitting the data stored in the shared memory to the I/O device local cache; and
reading the data transmitted from the shared memory to the I/O device local cache, by the I/O device.

4. The method of claim 3, wherein the multiprocessor system operates in accordance with a set of cache coherence protocols associated with CoreNet™ coherence fabric.

5. The method of claim 1, wherein the set of I/O devices includes at least one of an input/output memory management unit (IOMMU), a pattern matching engine, and a frame classification hardware.

6. A multiprocessor system, comprising:
a shared memory;
a set of core local caches connected to the shared memory;
a set of input/output (I/O) device local caches, connected to the shared memory, for receiving and storing data stored in the shared memory;
a set of processor cores, connected to the set of core local caches, for updating the data stored in the set of core local caches, wherein at least one processor core is associated with at least one core local cache of the set of core local caches, wherein the at least one processor core locks the at least one core local cache while updating the data stored therein, transmits the data stored in the at least one core local cache to the shared memory, and flags data stored in at least one I/O device local cache of the set of I/O device local caches as invalid, subsequent to the transmission of the data stored in the at least one core local cache to the shared memory; and
a set of I/O devices connected to the set of I/O device local caches, wherein at least one I/O device is associated with the at least one I/O device local cache, wherein the at least one I/O device determines a validity of the data stored in the at least one I/O device local cache, reads the data stored in the at least one I/O device local cache when the data is determined to be valid, and accesses the data stored in the shared memory when the data stored in the at least one I/O device local cache is determined to be invalid.

7. The multiprocessor system of claim 6, wherein the shared memory transmits the data stored therein to the least one I/O device local cache after receiving the data stored in the core local cache, wherein the shared memory transmits the data based on a request received from the at least one I/O device.

8. The multiprocessor system of claim 8, wherein the at least one I/O device reads the data transmitted by the shared memory to the at least one I/O device local cache.

9. The multiprocessor system of claim 6, wherein the set of I/O devices includes at least one of an input/output memory management unit (IOMMU), a pattern matching engine, and a frame classification hardware.

10. The multiprocessor system of claim 6, wherein the multiprocessor system operates in accordance with a set of protocols associated with CoreNet™ coherence fabric.
